(19) United States
(12) Patent Application Publication
(10) Pub. No.: US 2026/0233205 A1
(43) Pub. Date: Aug. 13, 2026

(54) HYDROCARBON PYROLYSIS FOR HYDROGEN PRODUCTION USING A TERNARY LIQUID METAL ALLOY

(71) Applicant: The Regents of the University of California, Oakland, CA (US)

(72) Inventors: Luning Chen, Shaoxing (CN); Ji Su, Richmond, CA (US)

(21) Appl. No.: 19/147,920

(22) PCT Filed: Jan. 16, 2024
(86) PCT No.: PCT/US2024/011646

§ 371 Date: Jul. 14, 2025

Related U.S. Application Data
(60) Provisional application No. 63/480,784, filed on Jan. 20, 2023.

(51) Int. Cl. B01J 23/887; B01J 35/27; B01J 37/08; B01J 37/18; C01B 3/26

(52) U.S. Cl. CPC B01J 23/8876; B01J 35/27; B01J 37/08; B01J 37/18; C01B 3/26; C01B 2203/0277; C01B 2203/1058; C01B 2203/1241

(57) ABSTRACT

This disclosure provides systems, methods, and apparatus related to hydrocarbon pyrolysis. In one aspect, a nickel (Ni) molybdenum (Mo) bismuth (Bi) alloy is provided. The NiMo—Bi alloy is molten. A hydrocarbon is pyrolyzed with the NiMo—Bi alloy.

### RELATED APPLICATIONS

This application claims priority to U.S. Provisional Patent Application No. 63/480,784, filed Jan. 20, 2023, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to hydrocarbon pyrolysis.

### BACKGROUND

Hydrogen (H₂) is emerging as a promising clean energy solution on a global scale. However, most H₂ production (90 million tons in 2020) comes from fossil fuels, such as natural gas, oil, and coal, which result in substantial CO₂ emissions (about 900 million tons). Water electrolysis is a green H₂ generation technology that uses renewable energy to produce CO₂-free H₂. However, currently it only contributes 2% of H₂ production given its high cost (5 to 6 USD per kg_{H2}) and high energy consumption (286 KJ/mol_{H2}).

Methane (CH₄) pyrolysis is another CO₂-free method for H₂ production that in addition produces valuable carbon materials, such as graphene, carbon nanotubes, and fullerenes. Although the methane pyrolysis reaction requires only 37.5 kJ of energy to produce one mole of H₂, it still requires high reaction temperatures (greater than about 1000° C.) to activate CH₄, leading to high energy demand, costly equipment, and unavoidable heat losses. More moderate reaction temperatures would mitigate by-product formation (e.g., ethane, ethylene, acetylene, aromatics), minimizing H₂ separation and purification operations. Development of catalysts that exhibit high catalytic activity, enable a moderate operating temperature, and have resistance to fouling and degradation, is needed.

Traditional supported transition metal catalysts (e.g., Ni, Co, Fe, Pt, or Pd) can catalyze methane pyrolysis under appropriate low reaction temperatures (500° C. to 600° C.) with low apparent activation energy (Ea) values ranging from 65 kJ/mol to 96 kJ/mol, but they suffer from deactivation by carbon coking and aromatics fouling. Molten liquid catalysts can overcome the deactivation issue by removing carbon products that float on top of the liquid catalysts and offer excellent durability. However, the high Eₐ of known molten liquid catalysts, ranging from 160 KJ/mol to 310 KJ/mol, still requires high temperatures for CH₄ activation.

### SUMMARY

One innovative aspect of the subject matter described in this disclosure can be implemented in a method including providing a nickel (Ni) molybdenum (Mo) bismuth (Bi) alloy, the NiMo—Bi alloy being molten. A hydrocarbon is pyrolyzed with the NiMo—Bi alloy.

In some implementations, the NiMo—Bi alloy is at a temperature of at least about 450° C. In some implementations, the NiMo—Bi alloy is at a temperature of about 450° C. to 1200° C. In some implementations, the NiMo—Bi alloy is at a temperature of about 450° C. to 800° C.

In some implementations, the hydrocarbon is a hydrocarbon from a group methane, ethane, propane, and butane. In some implementations, the hydrocarbon is methane. In some implementations, the hydrocarbon is a plastic or biomass.

In some implementations, the NiMo—Bi alloy is NiₓMo_{y}—Bi, with 1≤x≤3, and with 1≤y≤2. In some implementations, the NiMo—Bi alloy is a NiMo—Bi alloy from a group Ni₆Mo—Bi, Ni₄Mo—Bi, Ni₃Mo—Bi, Ni₃Mo₂—Bi, NiMo—Bi, and NiMo₂—Bi. In some implementations, the NiMo—Bi alloy is Ni₃Mo—Bi.

In some implementations, pyrolyzing the hydrocarbon includes passing the hydrocarbon through the NiMo—Bi alloy. In some implementations, pyrolyzing the hydrocarbon includes mixing the hydrocarbon with the NiMo—Bi alloy. In some implementations, pyrolyzing the hydrocarbon with the NiMo—Bi alloy is performed with the hydrocarbon at a pressure of about 1 atmosphere to 50 atmospheres. In some implementations, a residence time of the hydrocarbon in the NiMo—Bi alloy is about 5 seconds to 300 seconds.

In some implementations, the method further includes providing nickel oxide, molybdenum oxide, and bismuth metal. The nickel oxide, the molybdenum oxide, and the bismuth metal are heated in the presence of hydrogen to reduce the nickel oxide and the molybdenum oxide and to generate the NiMo—Bi alloy.

In some implementations, a molten salt is disposed on an upper surface of the NiMo—Bi alloy. In some implementations, a residence time of products of the hydrocarbon pyrolysis in the molten salt is about 5 seconds to 300 seconds. In some implementations, the salt is a salt from a group NaCl, NaBr, Nal, KCl, KBr, KI, MgCl₂, MgBr₂, ZnCl₂, CaCl₂, MnCl₂, FeCl₂ CuCl₂, NiCl₂, and mixtures thereof.

Another innovative aspect of the subject matter described in this disclosure can be implemented in a composition including a nickel (Ni) molybdenum (Mo) bismuth (Bi) alloy (NiMo—B alloy).

In some implementations, the NiMo—Bi alloy is NiₓMo_{y}—Bi, with 1≤x≤3, and with 1≤y≤2. In some implementations, the NiMo—Bi alloy is a NiMo—Bi alloy from a group Ni₆Mo—Bi, Ni₄Mo—Bi, Ni₃Mo—Bi, Ni₃Mo₂—Bi, NiMo—Bi, and NiMo₂—Bi. In some implementations, the NiMo—Bi alloy is Ni₃Mo—Bi. In some implementations, the NiMo—B alloy is molten.

Another innovative aspect of the subject matter described in this disclosure can be implemented in a composition consisting essentially of a nickel (Ni) molybdenum (Mo) bismuth (Bi) alloy (NiMo—B alloy).

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram illustrating a process for hydrocarbon pyrolysis.

FIGS. 2A-2E show catalytic data for the catalysts described herein. FIG. 2A shows the H₂ generation rate under different reaction temperatures and FIG. 2B shows the apparent activation energy of CH₄ pyrolysis over NiMo—Bi liquid alloy catalyst (with a molar ratio of Ni to Mo of 3:1). Reaction conditions: 4 ml/min CH₄, pressure: 206 kPa (30 psi), catalyst height: <1 cm. FIG. 2C shows the conversion and selectivity (left) and H₂ generation rate (right) at 800° C. over NiMo—Bi liquid alloy catalyst with different composition. All catalysts contained the same Ni amount. FIG. 2D shows the conversion and selectivity (left) and H₂ generation rate (right) at 800° C. over different liquid metal alloy catalysts. FIG. 2E shows a long-time stability measurement of CH₄ dehydrogenation over NiMo—Bi liquid alloy catalyst (with a molar ratio of Ni to Mo of 3:1) at 800° C. with 4 ml/min CH₄.

FIG. 3A shows nickel 2p x-ray photoelectron spectroscopy (XPS) of Ni—Bi and NiMo—Bi catalysts at room temperature. FIGS. 3B and 3C show Ni K-edge x-ray absorption near edge spectroscopy (XANES) spectra of Ni—Bi and NiMo—Bi catalysts at room temperature (RT) and operating temperature.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Recent findings indicate that the Ni—Bi liquid alloy metal catalyst could catalyze methane pyrolysis. However, the strong interaction between the active metal sites and solvent metal create a cage with positively charged Bi atoms encapsulating negatively charged Ni atoms. This atomic arrangement obstructs the CH₄ reaction and results in low activity with a high activation energy Eₐ of 208 KJ/mol. Reducing the cage effect of liquid metal catalysts is important to achieving a highly active catalyst for methane pyrolysis. Although liquid-metal catalysts have been used as new-generation catalysts in some specific catalytic processes, so far studies have not focused on tailoring the interaction between active sites and surrounding solution metal.

Compared with single-element metal materials, multi-element alloys have attracted attention in recent years because of their mechanical, physical, and chemical properties resulting from the entropy increase. The properties of alloy catalysts can be modified by additional elements, similar to how soluble metal complex catalysts can be modified by tuning ligands to modify active sites and their interaction with solvents.

As described herein, a third metal is added to a catalyst to regulate the interaction between the active metal and solution metals. In some embodiments, a catalyst for hydrocarbon pyrolysis comprises a nickel (Ni) molybdenum (Mo) bismuth (Bi) alloy (NiMo—Bi alloy). In some embodiments, a catalyst for hydrocarbon pyrolysis consists essentially of a nickel (Ni) molybdenum (Mo) bismuth (Bi) alloy (NiMo—Bi alloy). In some embodiments, the NiMo—Bi alloy is molten (i.e., in a liquid state). The introduction of Mo to the Ni—Bi liquid metal alloy decreases the cage effect from Bi atoms surrounding the Ni as a result of the Ni—Mo interaction.

In some embodiments, the NiMo—Bi alloy is NiₓMo_{y}-Bi, with 1≤x≤3, and with 1≤y ≤2. In some embodiments, the NiMo—Bi alloy is a NiMo—Bi alloy from a group Ni₆Mo—Bi, Ni₄Mo—Bi, Ni₃Mo—Bi, Ni₃Mo₂—Bi, NiMo—Bi, and NiMo₂—Bi. In some embodiments, the NiMo—Bi alloy is Ni₃Mo—Bi.

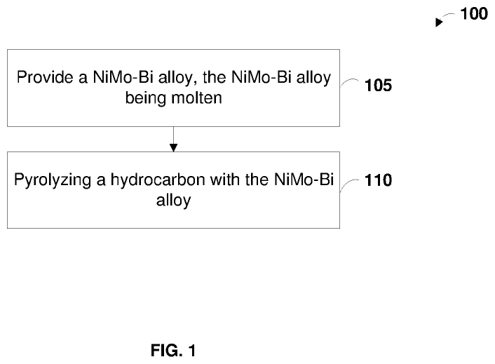

FIG. 1 shows an example of a flow diagram illustrating a process for hydrocarbon pyrolysis. Starting at block 105 of the process 100 shown in FIG. 1, a nickel (Ni) molybdenum (Mo) bismuth (Bi) alloy, is provided. The NiMo—Bi alloy is molten (i.e., the NiMo—Bi alloy is in a liquid state). At block 110, a hydrocarbon is pyrolyzed with the NiMo—Bi alloy.

In some embodiments, the hydrocarbon is in a gaseous state. In some embodiments, the hydrocarbon is a hydrocarbon from a group methane, ethane, propane, and butane. In some embodiments, the hydrocarbon is methane. In some embodiments, the hydrocarbon is a plastic. In some embodiments, the hydrocarbon is biomass.

In some embodiments, pyrolyzing the hydrocarbon includes passing or bubbling the hydrocarbon through the NiMo—Bi alloy. For example, with a volume of the NiMo—Bi alloy in a liquid state, a hydrocarbon in a gaseous state is introduced at the bottom of the volume of the NiMo—Bi alloy. The gaseous hydrocarbon bubbles or passes through the hydrocarbon, with hydrogen and carbon emerging from the top of the volume of the NiMo—Bi alloy. In some embodiments, pyrolyzing the hydrocarbon is performed with the hydrocarbon at a pressure of about 1 atmosphere to 50 atmospheres; i.e., the hydrocarbon is in a gaseous state and the pressure at which the hydrocarbon is introduced at the bottom of the volume of the NiMo—Bi alloy is about 1 atmosphere to 50 atmospheres. In some embodiments, a residence time of the hydrocarbon in the NiMo—Bi alloy is about 5 seconds to 300 seconds, about 5 seconds to 150 seconds, or about 5 seconds to 15 seconds.

In some embodiments, pyrolyzing the hydrocarbon includes mixing the hydrocarbon with the NiMo—Bi alloy. For example, when the hydrocarbon is in a solid state (e.g., a plastic or a biomass), the solid hydrocarbon is mixed with the NiMo—Bi alloy. In some embodiments, the solid hydrocarbon is in a small particulate or powder form when it is mixed with the NiMo—Bi alloy. In some embodiments, a residence time of the hydrocarbon in the NiMo—Bi alloy is about 5 seconds to 300 seconds, about 5 seconds to 150 seconds, or about 5 seconds to 15 seconds.

In some embodiments, the NiMo—Bi alloy is at a temperature of at least about 450° C. In some embodiments, the NiMo—Bi alloy is at a temperature of about 450° C. to 1200° C. In some embodiments, the NiMo—Bi alloy is at a temperature of about 450° C. to 800° C.

In some embodiments, the NiMo—Bi alloy is NiₓMo_{y}—Bi, with 1≤x≤3, and with 1≤y≤2. In some embodiments, the NiMo—Bi alloy is a NiMo—Bi alloy from a group Ni₆Mo—Bi, Ni₄Mo—Bi, Ni₃Mo—Bi, Ni₃Mo₂—Bi, NiMo—Bi, and NiMo₂—Bi. In some embodiments, the NiMo—Bi alloy is Ni₃Mo—Bi.

In some embodiments, the method further comprises, prior to block 105, providing nickel oxide, molybdenum oxide, and bismuth metal. The nickel oxide, the molybdenum oxide, and the bismuth metal are heated in the presence of hydrogen to reduce the nickel oxide and the molybdenum oxide and to generate the NiMo—Bi alloy.

The NiMo—Bi (Ni about 2.3 wt %, Mo about 1.3 wt %, and Bi about 96.4 wt %) catalysts displayed the maximum methane pyrolysis activity with a high H₂ generation efficiency (about 4.05 mL_{H2} g_{Ni}⁻¹ min⁻¹) at about 800° C., which is about 37 times faster than Ni—Bi catalysts. The Eₐ of the NiMo—Bi catalyst was about 81.2 kJ/mol, substantially lower than other reported molten liquid catalysts, approaching the level of supported solid metal catalysts (about 65 KJ/mol to 96 KJ/mol).

In some embodiments, when the hydrocarbon is in a gaseous state, a molten salt (i.e., a salt in a liquid state) is disposed on an upper surface of the NiMo—Bi alloy. In some embodiments, the salt is a salt from a group NaCl, NaBr, Nal, KCl, KBr, KI, MgCl₂, MgBr₂, ZnCl₂, CaCl₂, MnCl₂, FeCl₂ CuCl₂, NiCl₂, and mixtures thereof. In some embodiments, a residence time of products of the hydrocarbon pyrolysis in the molten salt is about 5 seconds to 300 seconds. The products of the hydrocarbon pyrolysis passing through the molten salt include carbon.

The molten salt (density ~2 g/cm³) will float on top of the molten NiMo—Bi alloy (density ~9 to 10 g/cm³). The molten salt will remove, at least in part, metal residue or contamination on the carbon that is produced by the hydrocarbon pyrolysis. Carbon produced by hydrocarbon pyrolysis using molten metals generally includes metal residues due to contact of the carbon with the molten metal and metal vapor. For some applications, it may be desirable to partially remove or remove such metal residues from the carbon vapor. The molten salt will also act as a cap on the NiMo—Bi alloy to reduce any contamination of the alloy and loss of metal vapor.

The following examples are intended to be examples of the embodiments disclosed herein, and are not intended to be limiting.

### EXAMPLE—Catalyst Preparation and Characterization

The best-performing NiMo—Bi catalyst (with an Ni-to-Mo molar ratio of 3:1) was prepared by directly reducing a mixture of nickel oxide, molybdenum oxide, and bismuth pellets in a quartz reactor with H₂ gas. After the reduction, the mixture melted into the liquid metal solution under N₂ and was ready to be used for the methane pyrolysis reaction.

A high-resolution powder x-ray diffraction (XRD) was used to identify the structure of the liquid NiMo—Bi catalyst after cooling down to room temperature under an inert atmosphere. A major crystal Bi phase with a symmetry group of R-3m (ICSD-64703), and a minor Bi₃Ni phase with Pnma symmetry (ICSD-391336) according to the fitting results, were identified. No appreciable amounts of phases related to the Mo component were detected compared with the Ni—Bi sample. The Ni—Mo interaction could enhance the solubility of Mo in Bi.

The phase transitions in a melting process were studies by in situ high-temperature XRD. The crystal phase of Bi disappeared at 260° C. near the Bi melting point of 270° C. The Bi₃Ni phase disappeared at 420° C., indicating that above this temperature, the NiMo—Bi catalyst remained in the liquid state, with Ni and Mo homogeneously distributed in the liquid solution. In situ high-temperature energy-dispersive spectroscopy mapping showed that at 500° C., the Ni, Mo, and Bi were uniformly distributed in the liquid alloy.

### EXAMPLE—Catalytic Studies

After catalyst preparation, CH₄ was introduced to a glass pyrolysis reactor and passed through the liquid catalyst to investigate the methane pyrolysis performance at different temperatures with a flow rate of 4 ml/min CH₄ and a 206 kPa (30 psi) pressure. The residence time of CH₄ through the liquid alloy catalyst was around 0.13 min.

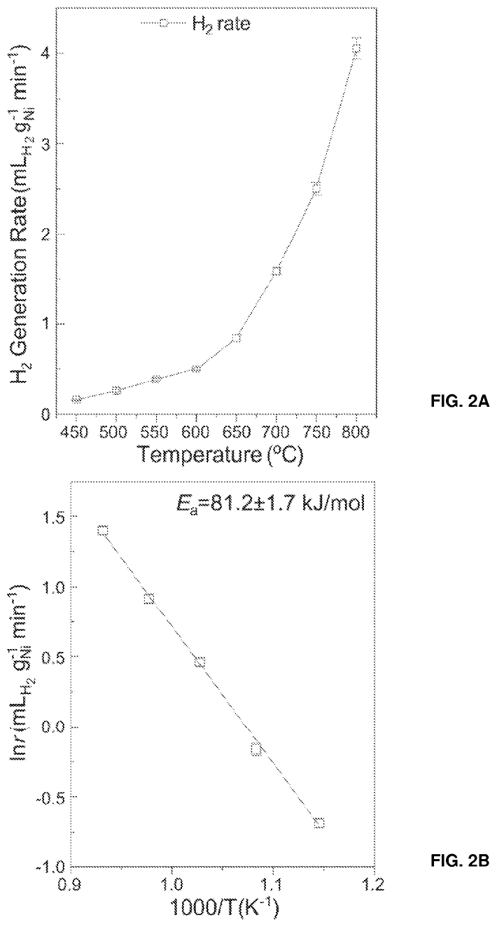

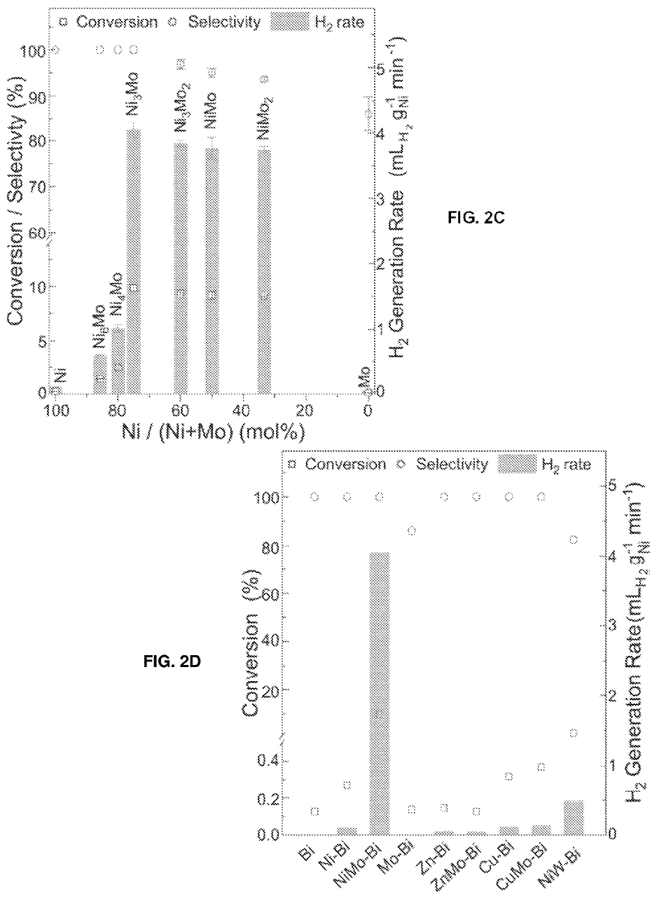

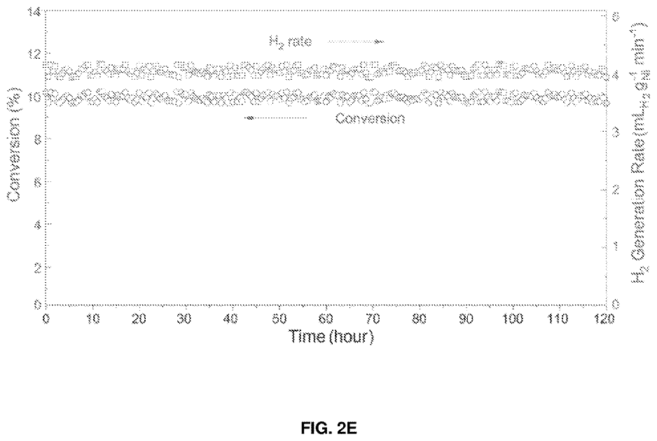

No H₂ was detected below 400° C. At 450° C., the catalysts were completely melted, and H₂ was detected with a generation rate of 0.16 mL_{H2} g_{Ni}⁻¹ min⁻¹. High temperature favored H₂ production and CH₄ conversion. Increasing the temperature to 800° C., the H₂ generation rate increased to 4.05 mL_{H2} g_{Ni}⁻¹ min⁻¹ and the CH₄ conversion reached 9.87% (see FIG. 2A), which is 37 times higher than the Ni—Bi catalyst (0.11 mL_{H2} g_{Ni}⁻¹ min⁻¹). No other by-products were detected under the operation temperatures, indicating complete CH₄ decomposition. Notably, this reaction system avoided the production of aromatics that result in fouling by acetylene by-products, which would cause catalyst deactivation and reaction blocking. The Eₐ of 81.2 kJ/mol was determined from the Arrhenius plots (see FIG. 2B). This value is much lower than in all reported molten liquid catalysts (166 to 310 kJ/mol) and comparable to that of solid metal catalysts.

The catalytic methane pyrolysis performance was further investigated under different reaction conditions. Lower flow rates or CH₄ concentration led to an increase in CH₄ conversion. When the CH₄ flow rate decreased to 1 ml/min, the conversion of CH₄ increased to 11.2%. Increasing the CH₄ pressure to 310 kPa (45 psi), the CH₄ conversion increased to 13.1% as a result of CH₄ solubility enhancement. Notably, the residence time of CH₄ could be tuned by the catalyst height. Longer residence times increase the CH₄ conversion. For a 5-cm-tall NiMo—Bi catalyst column, CH₄ conversion increased to 16.3%, which is higher than previous Ni—Bi catalysts even with higher catalyst columns (8 cm) and higher temperature (1000° C.). When 10% CH₄ diluted in N₂ was fed into the 5-cm-tall NiMo—Bi catalyst, the CH₄ conversion increased up to 51.7% under 800° C. and 2 bar of total pressure. These results indicated that CH₄ conversion could be further enhanced by reactor engineering optimization. Considering the higher activity of the NiMo—Bi catalyst and similar catalyst physical properties to the Ni—Bi catalyst, it is reasonable to assume that achieving a conversion close to the reaction equilibrium is feasible.

To determine the effect of different elements on catalytic results, the performance of liquid alloy catalysts with different Ni—Mo—Bi ratios was investigated (see FIG. 2C). Pure liquid Bi displayed no measurable activity for methane pyrolysis below 800° C. The Ni—Bi catalyst (without Mo) generated H₂ at a rate of 0.02 mL_{H2} g_{Ni}⁻¹ min⁻¹ starting at 650° C., which increased to 0.11 mL_{H2} g_{Ni}⁻¹ min⁻¹ at 800° C. Introducing Mo increased the reaction activity and reduced the onset temperature for methane pyrolysis. The H₂ generation rate over the Ni₆Mo—Bi catalyst was 0.59 mL_{H2} g_{Ni}⁻¹ min⁻¹ at 800° C. and reached 1.02 mL_{H2} g_{Ni}⁻¹ min⁻¹ for Ni₄Mo—Bi. The best catalytic performance was achieved at a ratio of Ni to Mo of 3:1. As the concentration of Mo was further increased, the H₂ generation rate slightly decreased, whereas the H₂ selectivity also decreased because of the formation of hydrocarbon by-products. These results demonstrate that in the NiMo—Bi liquid alloy system Ni was the active metal, with Bi acting as the solvent. Further, Mo, which has strong interaction with Ni, performed as the regulatory metal and enhanced the reaction activity by modulating the interaction of the solvent Bi metal and the active Ni metal.

Liquid alloy catalyst systems of different compositions, all in the liquid phase under the reaction temperature, were further investigated (see FIG. 2D). No catalytic activity was detected for either Zn—Bi or ZnMo—Bi catalysts. The Cu—Bi catalyst had similar catalytic activity to Ni—Bi. However, in contrast to the NiMo—Bi system, the addition of Mo did not appreciably enhance the reaction activity of the CuMo—Bi catalyst. Furthermore, when W was used instead of Mo in the NiMo—Bi system, despite its similar chemical and physical properties, the enhancement observed was much smaller compared with Mo, especially at high temperatures, due to the weaker interaction between Ni and W compared to that between Ni and Mo.

In addition to high activity and selectivity, the NiMo—Bi catalyst also exhibited good stability in the methane pyrolysis reaction. After 120 hours of measurement at 800° C. with a methane flow rate of 4 ml/min, the NiMo—Bi maintained good activity and selectivity without any deactivation relative to the initial performance (see FIG. 2E), which is better than most methane pyrolysis catalysts including molten liquid catalysts and traditional solid catalysts. The Ni and Mo were still uniformly dispersed in the Bi solution without any aggregation, suggesting that the NiMo—Bi could maintain stability over an even longer period.

During the reaction, the carbon product was segregated from the catalysts and accumulated on the catalyst surface. No sticky aromatic fouling species were detected on the wall of the quartz reactor. By further washing the carbon products with acetone, no aromatic products were detected by gas chromatography mass spectrometry. Notably, although the carbon could also catalyze the methane pyrolysis reaction, under the reaction conditions the activity of the NiMo—Bi catalyst was much higher than that of the formed carbon, indicating that all methane pyrolysis activity comes from NiMo—Bi catalysts. To further confirm this, 100-mg carbon products were used as a catalyst, which displayed low activity (0.6% conversion) and fast deactivation rate (36% in 5 min) under a similar reaction condition.

### EXAMPLE—Spectroscopy Studies

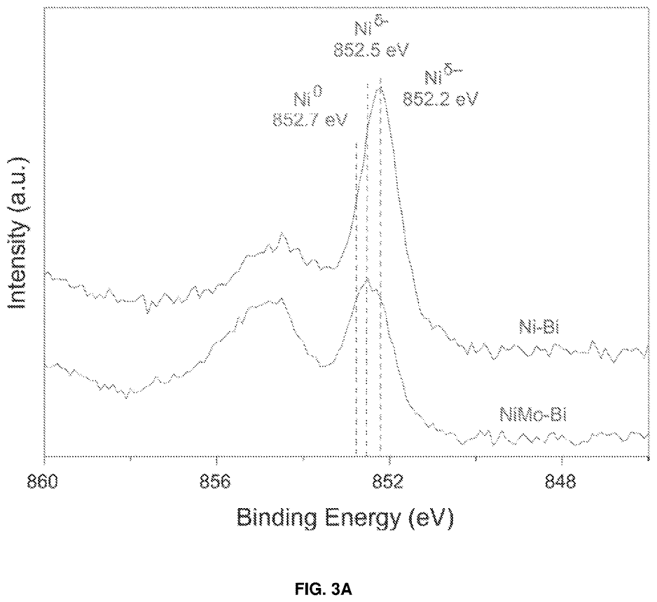

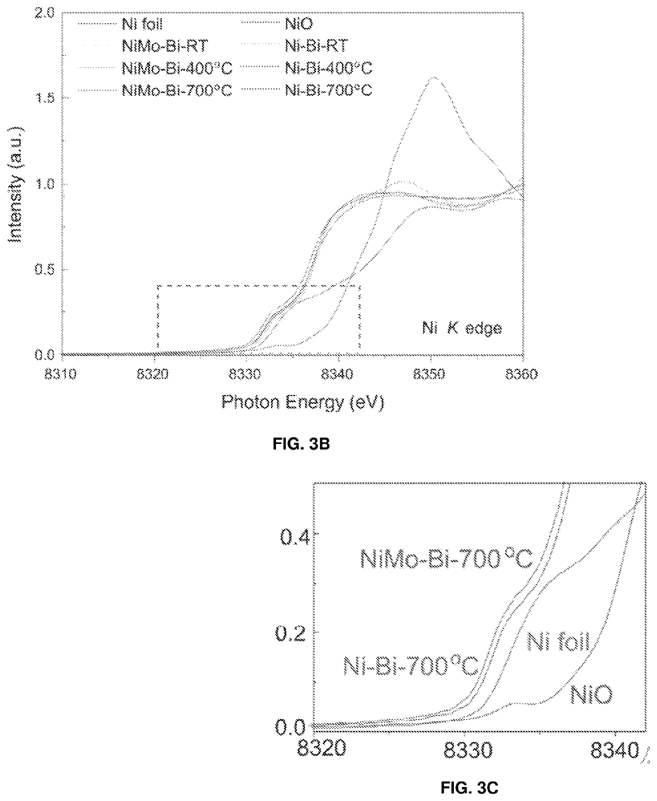

X-ray photoelectron spectroscopy (XPS) and in situ x-ray absorption near-edge spectroscopy (XANES) were applied to further investigate the chemical state of the species in the liquid alloy catalysts. XPS (see FIG. 3A) results show that the binding energy of the Ni 2p level in the Ni—Bi catalyst (852.2 eV) was 0.5 eV lower than that of metallic Ni (852.7 eV), indicating that Ni was negatively charged by electron transfer from surrounding Bi, in agreement with previous work. After Mo introduction, the peaks of Ni in NiMo—Bi shifted to a higher binding energy (852.5 eV), suggesting that the Ni in NiMo—Bi catalyst is closer to the metallic state but still negatively charged.

In situ high-temperature XANES was used to explore the Ni electronic structure at the reaction temperature (see FIGS. 3B and 3C). Consistent with XPS results, the adsorption edge energies of Ni in Ni—Bi and NiMo—Bi liquid alloy catalysts were lower than that of the Ni reference foil at room temperature, indicating its negative charge resulting from the interaction with Bi. Heating catalysts under an inert atmosphere, the adsorption edge energies of both Ni—Bi and NiMo—Bi moved to lower values, implying that in the liquid state, Ni is well mixed with Bi, favoring electron transfer from Bi to Ni. After Mo introduction, the strong interaction between Ni and Mo modulated the electronic state of Ni and reduced the interaction between Ni and Bi. Additionally, the XANES spectra of NiMo—Bi at Mo K-edge showed that at both high temperature and room temperature the valence state of Mo is different from that in the metallic foil and molybdenum oxide, which indicated that there is no Mo metal or molybdenum oxide in the liquid alloy.

Further, no Mo—Mo or Ni—Ni bonds were detected in the NiMo—Bi liquid alloy according to room temperature extended x-ray absorption fine structure spectra. The different radial distances and coordination environment of Ni and Mo of NiMo—Bi catalysts, compared with metal foil counterparts, further proved that Ni and Mo were uniformly dispersed without any aggregation. Moreover, the difference between the Ni—Bi and NiMo—Bi catalysts indicated the interaction between Ni and Mo, which is also different from the traditional Ni—Bi alloy. These spectroscopy studies successfully verified the existence of interactions between Ni and Mo in the NiMo—Bi melt, which resulted in Ni being less negatively charged and the enhancement of Mo solubility in the Ni—Bi system.

### Example—Theoretical Studies

A theoretical molecular dynamics simulation based on density functional theory was conducted to gain deeper insights into the electronic structure and reaction process in the liquid alloy catalysts. First, the dissolution process of the Mo₂ dimer and Mo cluster was simulated. In the pure molten Bi, the distance of two Mo atoms of Mo₂ dimer did not change as a result of the limited solubility of Mo, but in the presence of Ni the Mo—Mo distance would increase. Similar results were found in the Mo cluster in Bi—Ni liquid alloy. These results demonstrate that the solubility of Mo could be enhanced as a result of Ni—Mo interaction leading to Mo uniformly dispersing in the liquid alloy instead of aggregating. Then the average Ni electron charge in Ni—Bi and NiMo—Bi catalysts was monitored. In accordance with XPS and XANES results, the Ni dissolved in Bi with or without Mo are both negatively charged because of the difference of electron affinity between Ni and Bi. After Mo introduction the charge of the Ni atoms decreased, which could potentially increase the Ni mobility as well as decrease the interaction between Ni and surrounding Bi atoms.

To further understand this phenomenon, a molecular dynamics simulation at 1500 K was performed after embedding Ni atom in the Bi solution. The Ni atom was surrounded by Bi atoms. However, after Mo introduction, the Ni atom broke through the surrounding Bi atoms, making it more accessible to CH₄ molecules as catalytic active sites. Subsequently, CH₄ was introduced to the NiMo—Bi and Ni—Bi systems to follow the dissociation process at 1500 K. The number of H of CH₄ was calculated. The strong interaction between Ni and Bi made it more difficult for the CH₄ molecules to reach the caged Ni active sites, resulting in a reaction time to dissociate of about 300 femtosecond (fs) for the Ni—Bi system. However, the introduction of Mo weakened this cage effect and increased the possibility of interaction between Ni and CH₄, which caused CH₄ to start to dissociate at about 180 fs for the NiMo—Bi system. When W was used instead of Mo, the CH₄ started to dissociate at 252 fs for NiW—Bi, due to the weak interaction between Ni and W at a high temperature. All these results agree with the experimental observations.

### Conclusion

Further details regarding the embodiments described herein can be found in L. Chen et al., “Ternary NiMo—Bi liquid alloy catalyst for efficient hydrogen production from methane pyrolysis,” Science 381 (6660), 857-861, which is herein incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
providing a nickel (Ni) molybdenum (Mo) bismuth (Bi) alloy, the NiMo—Bi alloy being molten; and
pyrolyzing a hydrocarbon with the NiMo—Bi alloy.

2. (canceled)

3. The method of claim 1, wherein the NiMo—Bi alloy is at a temperature of about 450° C. to 1200° C.

4. (canceled)

5. The method of claim 1, wherein the hydrocarbon is a hydrocarbon from a group methane, ethane, propane, and butane.

6. The method of claim 1, wherein the hydrocarbon is methane.

7. (canceled)

8. The method of claim 1, wherein the NiMo—Bi alloy is NiₓMo_{y}—Bi, wherein 1≤x≤3, and wherein 1≤y≤2.

9. The method of claim 1, wherein the NiMo—Bi alloy is a NiMo—Bi alloy from a group Ni6Mo—Bi, Ni4Mo—Bi, Ni3Mo—Bi, Ni3Mo2—Bi, NiMo—Bi, and NiMo2—Bi.

10. The method of claim 1, wherein the NiMo—Bi alloy is Ni3Mo—Bi.

11. The method of claim 1, wherein pyrolyzing the hydrocarbon includes passing the hydrocarbon through the NiMo—Bi alloy.

12. The method of claim 1, wherein pyrolyzing the hydrocarbon includes mixing the hydrocarbon with the NiMo—Bi alloy.

13. The method of claim 1, wherein pyrolyzing the hydrocarbon with the NiMo—Bi alloy is performed with the hydrocarbon at a pressure of about 1 atmosphere to 50 atmospheres.

14. The method of claim 1, wherein a residence time of the hydrocarbon in the NiMo—Bi alloy is about 5 seconds to 300 seconds.

15. The method of claim 1, further comprising:
providing nickel oxide, molybdenum oxide, and bismuth metal; and
heating the nickel oxide, the molybdenum oxide, and the bismuth metal in the presence of hydrogen to reduce the nickel oxide and the molybdenum oxide and to generate the NiMo—Bi alloy.

16. The method of claim 1, wherein a molten salt is disposed on an upper surface of the NiMo—Bi alloy.

17. The method of claim 16, wherein a residence time of products of the hydrocarbon pyrolysis in the molten salt is about 5 seconds to 300 seconds.

18. The method of claim 16, wherein the salt is a salt from a group NaCl, NaBr, Nal, KCl, KBr, KI, MgCl₂, MgBr₂, ZnCl₂, CaCl₂, MnCl₂, FeCl₂ CuCl₂, NiCl₂, and mixtures thereof.

19. A catalyst for hydrocarbon pyrolysis, the catalyst comprising:
a nickel (Ni) molybdenum (Mo) bismuth (Bi) alloy (NiMo—B alloy).

20. The catalyst of claim 19, wherein the NiMo—Bi alloy is NiₓMo_{y}—Bi, wherein 1≤x≤3, and wherein 1≤y≤2.

21. The catalyst of claim 19, wherein the NiMo—Bi alloy is a NiMo—Bi alloy from a group Ni₆Mo—Bi, Ni₄Mo—Bi, Ni₃Mo—Bi, Ni₃Mo₂—Bi, NiMo—Bi, and NiMo₂—Bi.

22. The catalyst of claim 19, wherein the NiMo—Bi alloy is Ni₃Mo—Bi.

23. The catalyst of claim 19, wherein the catalyst is molten.

24. (canceled)
